(19) United States
(12) Patent Application Publication
(10) Pub. No.: US 2014/0012813 A1
(43) Pub. Date: Jan. 9, 2014

(54) METHOD AND APPARATUS FOR SYNCHRONIZING PERSONAL INFORMATION

(71) Applicants: Gyu-Bong Oh, Suwon-si (KR); Sun-Gi Gu, Yongin-si (KR); Sung-Oh Hwang, Yongin-si (KR)

(72) Inventors: Gyu-Bong Oh, Suwon-si (KR); Sun-Gi Gu, Yongin-si (KR); Sung-Oh Hwang, Yongin-si (KR)

(73) Assignee: Samsung Electronics Co., Ltd., Suwon-si, Gyeonggi-do (KR)

(21) Appl. No.: 14/004,856

(22) PCT Filed: Mar. 14, 2012
(86) PCT No.: PCT/KR2012/001852

§ 371 Date: Sep. 12, 2013

(30) Foreign Application Priority Data
Mar. 14, 2011 (KR) 10-2011-0022583

(51) Int. Cl. G06F 17/30

(52) U.S. Cl. CPC G06F 17/30575
USPC 707/635; 707/610

(57) ABSTRACT

A method for synchronizing converged address book personal information managed by a converged address book system with non-converged address book personal information managed by a non-converged address book system, which does not support a converged address book service, by a server apparatus supporting the converged address book service is provided. The method includes identifying a generation of a synchronization event for urging a synchronization between converged address book personal information corresponding to a user terminal and non-converged address book personal information corresponding to the user terminal, configuring synchronization personal information including at least a part of the converged address book personal information, and exporting the synchronization personal information to a non-converged address book system related to the user terminal.

### CROSS-REFERENCE TO RELATED APPLICATION(S)

This application is a National Stage application under 35 U.S.C. §371 of an International application filed on Mar. 14, 2012 and assigned application No. PCT/KR2012/001852, and claims the benefit under 35 U.S.C. §365(b) of a Korean patent application filed on Mar. 14, 2011 in the Korean Intellectual Property Office and assigned Serial No. 10-2011-0022583, the entire disclosure of which is hereby incorporated by reference.

### TECHNICAL FIELD

The present disclosure relates to a Converged Address Book (CAB) service, which enables a user terminal to access single address book data. More particularly, the present disclosure relates to a method and an apparatus for synchronizing personal information managed through a converged address book service with personal information of a communication network, which does not receive the converged address book service.

### BACKGROUND

A Converged Address Book (CAB) service refers to a service provided for improving a user's experience with an address book and a function of the address book by storing a single address book corresponding to a specific user in a network and enabling a plurality of user terminals belonging to the specific user to access the single address book.

FIG. 1 is a diagram illustrating a converged address book system providing a converged address book service according to the related art.

Referring to FIG. 1, the converged address book system includes a CAB client 10, a CAB server 20, and a CAB eXtensible Markup Language (XML) Document Management Server (XDMS) 30.

The CAB client 10 is included in a user terminal and communicates with the CAB server 20. The CAB client 10 plays a role of authenticating a CAB user and transmitting requirements of the CAB user, for example, an address (contact) subscription, an address finding, an address sharing, an interaction with a related-art address book, or a management of user preferences to the CAB server 20. Further, the CAB client 10 synchronizes a converged address book and contact information, that is, Personal Contact Card (PCC) information stored in the user terminal with corresponding information stored in a storage space of the network.

The CAB server 30 is a main network element in the converged address book system and plays a role of receiving a request of the CAB user from the CAB client 10 and processing the received request. The CAB server 30 includes an Address Book (AB) synchronization function 21, an InterWorking Function (IWF) 22, a contact status function 23, a trusted XDMC 24, a contact share function 25, and a contact subscription function 26.

A main function of the CAB server 30 includes mutually authenticating the CAB client, storing a CAB address, synchronizing address information between the user terminal and the CAB XDMS 30, and receiving an address information renewal from the contact subscription function to reflect the renewal. Further, the main function of the CAB server 30, which corresponds to a network element reflecting a contact subscription/sharing/conversion and user preference/policy, includes a function of collecting a CAB user preference XML document from the User Preference (UP) application usage unit (CAB UP App. Usage) 33 of the CAB XDMS 30, a function of subscribing the address book receiving a request for a subscription of the CAB user, a function of applying a personal preference of data received through the contact subscription and reflecting the personal preference to the address book, a function of maintaining subscription state information, a function of sharing the contact by sharing the PCC information or the converged address book, and a function of interworking with a related-art address book system or exposing an interface to an external enabler.

The CAB XDMS 30 manages address book data of the user in relation to the CAB enabler. Accordingly, the CAB XDMS 30 includes an address book application usage unit (CAB AB App. Usage) 31 storing the converged address book and a contact status, the user preference application usage unit (CAB UP App. Usage) 33, a Feature Handling (FH) application usage unit (CAB FH App. Usage) 34 for managing a converged address book service request/response, and a PCC application usage unit (PCC App. Usage) 32 for storing PCC information.

The converged address book service system further includes an XDMC for accessing various application usage units, a Session Initiation Protocol (SIP)/Internet Protocol (IP) core network for a message routing with entities of an external domain, and a PUSH enabler for transmitting a notice message of non-SIP terminals.

A main function of the converged address book service includes the following.
1) Address Book Synchronization

A. When the CAB user modifies a local address book within the user terminal, the CAB client 10 transfers modified information to the CAB server 20 by using a CAB-1 Synchronization Markup Language (SyncML) interface.

B. The address book synchronization function 21 within the CAB server 20 reflects modified contents of the local address book to the address book application usage unit 31 by using an XML Document Management (XDM) agent. At this time, when data formats between the CAB client 10 and the address book application usage unit 31 are different, a format translation is generated and a data loss may be generated according to the format translation between different data formats.
(2) Contact Subscription

A. The CAB client 10 transfers an XML Configuration Access Protocol (XCAP) request for a contact subscription to the user preference application usage unit 33.

B. The user preference application usage unit 33 detects a contact of a receiver subscribing an address book from the XCAP request and adds the detected contact to a contact subscription list.

C. The user preference application usage unit 33 informs the contact subscription function 26 within the CAB server 20 of a document change of the contact subscription list.

D. The contact subscription function 26 directly transfers a contact subscription request for the PCC of the receiver from the contact subscription list to a domain of a receiving side or transfers it through a subscription proxy.

E. When the PCC application usage unit of the receiving side receives the contact subscription request, the PCC application usage unit identifies a user preference and then informs the receiver of a subscription result.

F. The CAB client 10 can perform the contact subscription of the XDM Document Command Protocol (XDCP) by using a SUBSCRIBE and a PUSH enabler in an environment where an SIP is not supported.
(3) Contact sharing

A. The CAB client 10 transfers an XCAP request for the contact sharing to the feature handling Application Usage unit 34.

B. The feature handling application usage unit 34 detects a receiver's contact to be shared and a reference of shared data from an address sharing XCAP request and stores it in the feature handling application usage unit 34.

C. The feature handling application usage unit 34 informs the contact share function 25 within the CAB server 20 of a document change related to the CAB feature handling.

D. The contact share function 25 grasps a contact status from the address book application usage unit 31 based on the receiver's contact.

i. When the receiver is the CAB user, the contact share function 25 generates the contact share request and then transfers contact information to a CAB XDMS (CAB AB App. Usage or CAB PCC App. Usage), to which the contact share function 25 desires to transfer the contact information, by using a subsequent XDM agent. A corresponding application usage unit transfers shared contact information to the receiver based on an XDM forward mechanism.

ii. When the receiver is not the CAB user, the contact share function 25 receives contact information from the CAB XDMS (CAB AB App. Usage or CAB PCC App. Usage), to which the contact share function 25 desires to transfer the contact information, makes a request for a format conversion to a legacy format from the IWF 22, and then transfers it to the receiver through a messaging enabler.
(4) Contact Search

A. The CAB client 10 transfers a contact search request for an address book or a PCC of the CAB client 10 or an address book or a PCC of another domain address book through an aggregation proxy/search proxy of an XDM enabler.

B. The contact search request is routed to a corresponding application usage unit by a search proxy and the corresponding application usage unit transfers a search result to the CAB client 10.

C. When the CAB client 10 searches for an external directory without searching for the CAB system, the CAB client 10 changes the contact search request to an external search request through the IWF 22 of the CAB server 20 and transfers the changed request to the external directory. The IWF 22 of the CAB server 20 changes the received external search result to a standard XML search result and then transfers the changed search result to the CAB client 10.
(5) Fetching an External Address Book from a Non-Converged Address Book System (Non-CAB System)

A. The CAB client 10 transfers an XCAP request for the import of non-converged address book data to the feature handling application usage unit 34.

B. The feature handling application usage unit 34 detects converged address book resources, a credential, and a scheduled interval from the XCAP request and adds them to a CAB feature handling document.

C. The feature handling application usage unit 34 informs the IWF 22 within the CAB server 20 of a document change of the CAB feature handling document.

D. The IWF 22 obtains information on non-converged address book data, stores the obtained data in the address book application usage unit 31 according to the CAB user preference, and then informs the CAB client 10 of the start of the address book synchronization.

In the converged address book service, there is no proposed method of synchronizing contact information stored in the converged address book system and contact information stored in the non-converged address book system. However, a contact method through fetching external contact information can implement some of the contact information synchronization and the synchronization process is as shown in FIG. 2 according to the related art. FIG. 2 illustrates a process of renewing contact information according to the related art.

Referring to FIG. 2, the CAB client 10 of the user terminal stores a request for non-converged address book information for fetching contact information from the non-converged address book system to an inside of the feature handling application usage unit 34 of the CAB XDMS 30 at operation 111.

The IWF 22 of the CAB server 20 can obtain information on the XDM document change generated at operation 111 from the feature handling application usage unit 34 through document management or document subscription/notification on a regular period at operation 113.

The IWF 22 of the CAB server 20 requests information on the address book to the non-converged address book system of the user at operation 115 and obtains information on the non-converged address book stored in the non-converged address book system 40 of the user at operation 117.

The IWF 22 changes the information obtained at operation 119 to a CAB format and then stores the changed information in the address book application usage unit 31 of the CAB XDMS 30 according to the user preference. Further, the CAB server 20 synchronizes contact information of the CAB client 10 by using a server-alerted notification by an Open Mobile Alliance (OMA) Data Synchronization (DS) server at operation 121.

A method of renewing contacts through fetching the contact information has the following problems.

1. For a renewal, a method of synchronizing the contact information with another external address book instead of the CAB service system by the network or the CAB client of the user is not still provided.

2. After renewing the contact through fetching the contact information as shown in FIG. 2, a third external address book may not be synchronized.

3. A method of synchronizing personal profile information handled in the converged address book other than the contact information, that is, the PCC with a profile of the non-converged address book system or synchronizing other personal contents, for example, a picture, a dynamic image, a voice file is not still provided.

As described above, the related-art method is unsuitable as a method of synchronizing contact information with the non-converged address book system.

Furthermore, there is no method which can synchronize personal contents such as PCC information corresponding to user profile information, a dynamic image belonging to the user, an image, or audio data among personal information managed in the converged address book service with corresponding personal information in the non-converged address book system.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus, which can synchronize converged address book data including personal information such as contact information or Personal Contact Card (PCC) information managed in the converged address book service system with personal information managed in the non-converged address book system.

Another aspect of the present disclosure is to provide a method and an apparatus for transmitting/receiving data, which provide a communication service without wasting resources, power, and memories at a high speed in synchronizing address book data in a communication system for supporting various types of the communication services.

Still another aspect of the present disclosure is to provide a method and an apparatus, which can provide a converged address book service to a user in various communication systems.

Still another aspect of the present disclosure is to provide a method and an apparatus, which can easily and quickly provide a converged address book service according to a selection of a user's opinion by defining a method of synchronizing personal information between address book data of the non-converged address book system and address book data of the converged address book system through an export request for requesting to export personal information such as PCC information or contact information in the converged address book system to an outside.

In accordance with an aspect of the present disclosure, a method of synchronizing converged address book personal information managed by a converged address book system with non-converged address book personal information managed by a non-converged address book system, which does not support a converged address book service, by a server apparatus supporting the converged address book service is provided. The method includes identifying a generation of a synchronization event for urging a synchronization between converged address book personal information corresponding to a user terminal and non-converged address book personal information corresponding to the user terminal, configuring synchronization personal information including at least a part of the converged address book personal information, and exporting the synchronization personal information to a non-converged address book system related to the user terminal.

In accordance with another aspect of the present disclosure, a server apparatus for supporting a converged address book service and synchronizing converged address book personal information managed by a converged address book system with non-converged address book personal information managed by a non-converged address book system, which does not support the converged address book service is provided. The server apparatus includes a synchronization event processor configured to identify a generation of a synchronization event for urging a synchronization between converged address book personal information corresponding to a user terminal and non-converged address book personal information corresponding to the user terminal, and a synchronization personal information configuration unit configured to configure synchronization personal information including at least a part of the converged address book personal information and exporting the synchronization personal information to a non-converged address book system related to the user terminal.

In accordance with yet another aspect of the present disclosure, method of synchronizing converged address book personal information managed by a converged address book system with non-converged address book personal information managed by a non-converged address book system, which does not support a converged address book service, by a user terminal supporting the converged address book service, is provided. The method includes configuring an export request message for requesting to export at least a part of converged address book personal information stored in a server apparatus for the user terminal to a non-converged address book system, and transmitting the export request message to the server apparatus. The export request message includes an address of the non-converged address book system, access authentication information of the non-converged address book system, and identification information on the converged address book personal information to be exported.

In accordance with still another aspect of the present disclosure, a user terminal for supporting a converged address book service and synchronizing converged address book personal information managed by a converged address book system with non-converged address book personal information managed by a non-converged address book system, which does not support the converged address book services, is provided. The user terminal including a transceiver configured for one of transmitting data to and receiving data from a server apparatus storing converged address book personal information corresponding to the user terminal, and a client configured for configuring an export request message for requesting to export at least a part of the converged address book personal information to a non-converged address book system and transmitting the export request message to the server apparatus through the transceiver. The export request message includes an address of the non-converged address book system, access authentication information of the non-converged address book system, and identification information on converged address book personal information to be exported.

In accordance with the present disclosure, it is possible to efficiently manage personal information by synchronizing address book data stored in the converged address book system with personal information stored in a plurality of non-converged address book systems through the export of personal information such as address book information or PCC information from the converged address book system by a Converged Address Book (CAB) user.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a construction of a converged address book system according to the related art;

FIG. 2 illustrates a process of renewing contact information according to the related art;

FIG. 3 illustrates a construction of a user terminal according to an embodiment of the present disclosure;

FIG. 4 illustrates a construction of a Converged Address Book (CAB) server according to an embodiment of the present disclosure;

FIG. 5 illustrates a construction of a CAB eXtensible Markup Language (XML) Document Management Server (XDMS) according to an embodiment of the present disclosure;

FIG. 6 illustrates a process in which a CAB server synchronizes personal information in a converged address book system according to an embodiment of the present disclosure; and

FIGS. 7, 8, 9, 10, 11, 12, and 13 illustrate a process of synchronizing CAB personal information according to various embodiments of the present disclosure.

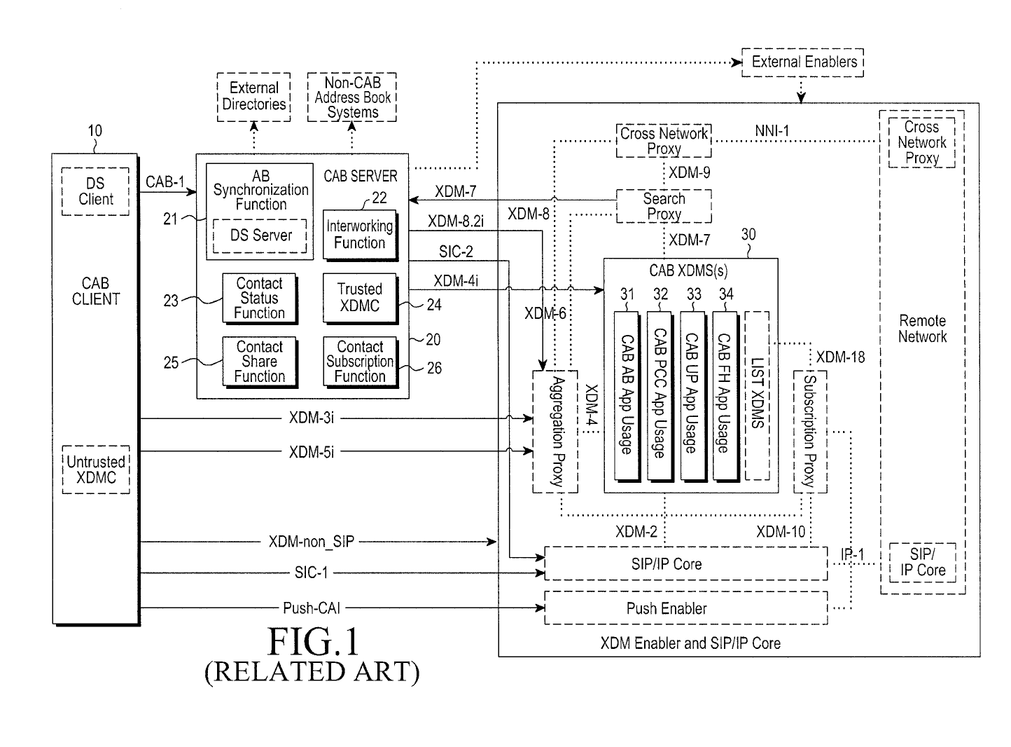

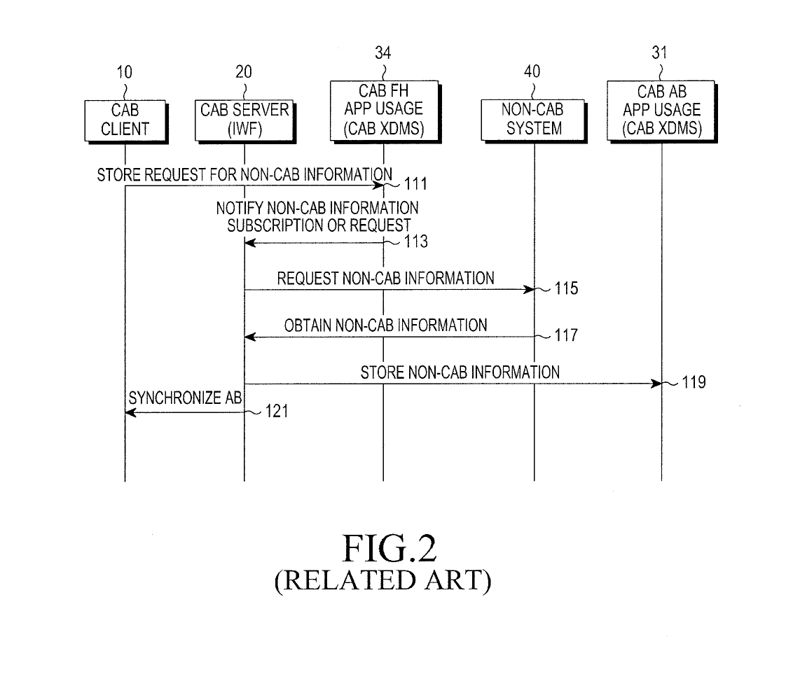

Throughout the drawings, it should be noted that like reference numbers are used to depict the same or similar elements, features, and structures

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure provides a method and an apparatus, which can easily and quickly manage personal information according to a selection of a user's opinion, by providing a method of synchronizing personal information such as Address Book (AB) information or Personal Contact Card (PCC) information managed in a Converged Address Book (CAB) system with personal information managed in an external network, which does not support a converged address book service.

Accordingly, the present disclosure defines a schema, by which personal information such as personal profile information or address book information of the converged address book system can be exported, within the CAB feature handling application usage unit (CAB Feature Handler Application (App.) Usage) in order to synchronize converged address book personal information such as user profile information (e.g., PCC information) and address book information of the converged address book with corresponding personal information of the network and also defines whether the converged address book personal information is synchronized with an address book/profile system of an external network within the user preference. Therefore, when the personal information such as the PCC information and the address book information of the converged address book system is renewed by the user, the personal information is synchronized with the address/profile system of the external network according to the user preference.

In the following description, a communication network, which does not support the converged address book service, is referred to as an external network, and a system, which stores and manages personal information such as an address book, a user profile, or personal contents in the external network, is referred to as a non-converged address book system.

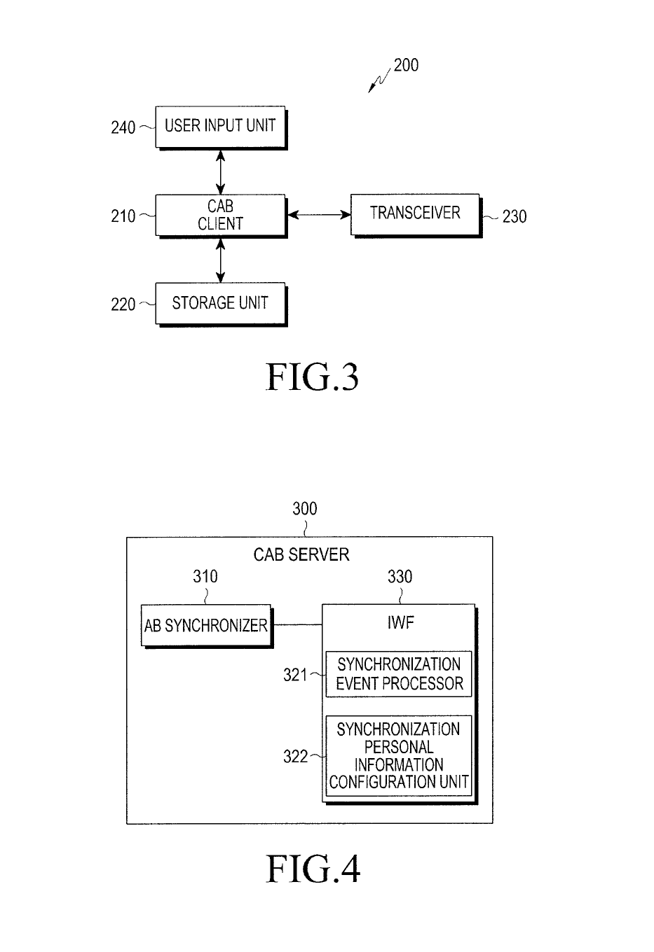

An example of a user terminal to which the present disclosure is applied is illustrated in FIG. 3. FIG. 3 illustrates a construction of a user terminal according to an embodiment of the present disclosure. The user terminal 200 refers to an apparatus capable of communicating with a network entity or another apparatus and includes, for example, a mobile communication terminal, a mobile phone, a Personal Digital Assistant (PDA), a smart phone, a notebook, a personal computer, etc.

Referring to FIG. 3, the user terminal 200 includes a CAB client 210, a storage unit 220, a transceiver 230, and a user input unit 240.

The transceiver 230 transmits/receives data or a message to/from a network or another apparatus under a control of the CAB client 210 and the message or data received by the transceiver 230 is transferred to the CAB client 210.

The user input unit 240 corresponds to an element providing an interface between a user and a user terminal and transfers data input by the user to the CAB client 210.

The storage unit 220 stores a program for a processing and a control, reference data, and various renewable storage data, and the stored program and data are provided to a working memory of the CAB client 210. Further, the storage unit 220 stores converged address book data (i.e., CAB data) according to various embodiments of the present disclosure. The converged address book data corresponds to converged address book personal information managed by the converged address book system, and includes, for example, Address Book information (AB information) and PCC information and may further include personal contents such as an image, a dynamic image, and audio data.

The CAB client 210 controls communication with the network entity of the converged address book system and plays a role of authenticating the CAB user and transmitting requirements of the CAB user, for example, an address subscription, an address finding, an address sharing, an interaction with the related-art address book, or user preference management to the converged address book system. Further, the CAB client 210 synchronizes the converged address book data stored in the storage unit 220 with converged address book data stored in the network entity, for example, the CAB eXtensible Markup Language (XML) Document Management Server (XDMS).

Further, the CAB client 210 configures a request message for a converged address book data export and the request message is stored in the network entity, for example, the CAB XDMS or the CAB server according to an embodiment of the present disclosure. In the present disclosure, it is assumed that the CAB XDMS corresponds to a space for storing the request message for the address book data export but the request message may be stored in another network entity of the converged address book system without departing from the scope of the present disclosure. When the request message for the address book data export transmitted by the CAB client according to a construction method of the converged address book system is transferred to the CAB server instead of the CAB XDMS server, the request message and a response message to the request message may be managed by storing the request message in a storage space within the CAB server or the CAB XDMS. After the storage of the corresponding message, the InterWorking Function (IWF) performs an operation for synchronizing the non-converged address book information, that is, makes a request for the address book data export. A description of the detailed operation for the synchronization will be additionally described later. The request message for the converged address book data export refers to a message for requesting to export the personal information stored in the CAB XDMS to a specific non-converged address book system in order to synchronize the personal information stored in the CAB XDMS with corresponding personal information stored in the non-converged address book system of the external network. At this time, the request message for the converged address book data export includes identification information on personal information to be exported, an address of the non-converged address book system storing corresponding received personal information, and access authentication information of the non-converged address book system.

According to an embodiment of the present disclosure, the non-converged address book system and the personal information to be synchronized may be selected by the user. For example, the CAB client 210 can provide a synchronization request menu to the user and the user can select personal information to be exported and a non-converged address book system to receive the personal information by using the synchronization request menu. At this time, the personal information transmitted to the non-converged address book system for the personal information synchronization, that is, exported personal information may be entire converged address book data or one of the address book information, the PCC information, and the personal contents. Alternatively, the exported personal information may be some of the address book information, some of the PCC information, or some of the personal contents.

The CAB client 210 configures a request message for an address book data import and the request message is stored in the network entity, for example, the CAB XDMS or the CAB server according to an embodiment of the present disclosure. In the present disclosure, it is assumed that the CAB XDMS corresponds to a storage space of the request message for the address book data import but the request message may be stored in another network entity of the converged address book system without departing from the scope of the present disclosure. When the request message for the address book data import transmitted by the CAB client according to a construction method of the converged address book system is transferred to the CAB server instead of the CAB XDMS server, the request message and a response message to the request message may be managed by storing the request message in a storage space within the CAB server or the CAB XDMS. After the storage of the corresponding message, the IWF performs an operation for synchronizing the non-converged address book information, that is, makes a request for the address book data import. A description of the detailed operation for the synchronization will be additionally described later. The request message for the converged address book data import refers to a message for obtaining the personal information stored in the non-converged address book system and requesting to store the obtained personal information in the converged address book system. Accordingly, the request message for the converged address book data import includes identification information on personal information to be imported, an address of the non-converged address book system storing corresponding personal information, and access authentication information of the non-converged address book system. According to various embodiments of the present disclosure, the non-converged address book system may be selected by the user.

Further, when the personal information stored in the network entity, for example, the CAB XDMS is changed, that is, when converged address book data is changed, the CAB client 210 can set a request for synchronizing the changed personal information with the non-converged address book system of the external network in the user preference. The user preference is stored in the CAB XDMS. When the request for the synchronization is set in the user preference, the CAB client 210 configures a personal information export list (contact export entry) and includes the configured list in the user preference according to an embodiment of the present disclosure. The personal information export list includes information on whether changed personal information is exported to the non-converged address book system, an address of the non-converged address book system to receive and store the changed personal information, and access authentication information of the corresponding non-converged address book system.

Furthermore, the CAB client 210 controls an operation of the user terminal 200 in a synchronization process described in the following description according to various embodiments of the present disclosure.

FIG. 4 illustrates an example of a CAB server according to an embodiment of the present disclosure. A CAB server 300 is a main network entity in the CAB system and corresponds to an apparatus playing a role of receiving requests of the user from the user terminal 200 and processing the received requests. A main function of the CAB server includes mutually authenticating the CAB client, controlling the storage of the converged address book data, synchronizing converged address book data between the user terminal 200 and the CAB XDMS, and receiving an address book renewal from the address subscription function to reflect the received address book renewal. Further, the network server is a network element reflecting an address book subscription/sharing/conversion and user preference/policy and includes a function of collecting a CAB user preference XML document from a user preference application usage unit (CAB UP App. Usage) of a CAB XDMS, a function of subscribing the address book receiving a request for a subscription of the CAB user, a function of applying a personal preference of data received through the address book subscription and reflecting the address book, a function of maintaining subscription state information, a function of sharing the address book by sharing the PCC information or the converged address book, and a function of interworking with a related-art address book system or exposing an interface to an external enabler.

The address book synchronization function may be implemented through an address book subscription/notification between the CAB XDMS and the CAB client, not the CAB server, according to a method of constructing functions of the converged address book system in the converged address book system. In this case, the CAB server does not include a separate address book synchronizer shown in FIG. 4.

Referring to FIG. 4, the CAB server 300 includes an address book synchronizer 310 and an IWF 330.

The address book synchronizer 310 controls converged address book data stored in the user terminal 200 and the converged address book data stored in the network entity, for example, the CAB XDMS according to the synchronization.

The IWF 330 performs an operation for synchronizing the converged address book data that is, the personal information stored in the CAB XDMS with the corresponding personal data stored in the non-converged address book system, which does not support the converged address book service, according to the present disclosure. Accordingly, the IWF 330may include a synchronization event processor 321 and a synchronization personal information configuration unit 322.

The synchronization event processor 321 identifies and processes a generation of a synchronization event according to the present disclosure. The synchronization event refers to an event for urging the synchronization between the converged address book personal information managed in the converged address book system and the corresponding non-converged address book personal information stored in the non-converged address book system of the external network.

For example, the synchronization event may be generated according to a converged address book data export request for requesting to export the converged address book data to the non-converged address book system. The converged address book data export request is stored in the CAB XDMS or the CAB server. In the present disclosure, it is assumed that the CAB XDMS corresponds to a space for storing the request message for the address book data export but the request message may be stored in another network entity of the converged address book system without departing from the scope of the present disclosure. When the request message for the address book data export transmitted by the CAB client according to a construction method of the converged address book system is transferred to the CAB server instead of the CAB XDMS server, the request message and a response message to the request message may be managed by storing the request message in a storage space within the CAB server or the CAB XDMS. After the storage of the corresponding message, the IWF performs an operation for synchronizing the corresponding address book information. A description of the detailed operation for the synchronization will be additionally described later. When the converged address book data export request from the user terminal 200 is stored, the CAB XDMS notifies the IWF 330 of the storage or the IWF 330 periodically identifies whether the converged address book data export request is stored, so that the event processor 321 may identify the generation of the synchronization event.

For another example, the synchronization event may be generated when the personal information stored in the CAB XDMS is changed, that is, when the converged address book data is changed and a request for exporting the changed converged address book data to the external network is set. For example, as the personal information of the non-converged address book system is imported to the converged address book system, a synchronization event for synchronizing a third converged address book system may be generated. For another example, as address information on the CAB is renewed by the CAB user, a synchronization event for synchronizing the non-converged address book system may be generated. Further, as the address information on the CAB is renewed by a network interface, an event for synchronizing the non-converged address book system may be generated. Alternatively, as profile information from the non-converged address book system is imported, a synchronization event for synchronizing a third non-converged address book system may be generated. Further, a synchronization event for synchronizing the non-converged address book system according to a renewal of the PCC information by the CAB user may be generated. Alternatively, a synchronization event for synchronizing the non-converged address book system according to a renewal of the PCC information by the network interface may be generated.

According to the present disclosure, when the converged address book personal information stored in the CAB XDMS is changed, a request for synchronizing the changed converged address book personal information with the non-converged address book system may be included in the user preference and stored in the CAB XDMS. When the synchronization request is included in the user preference, the user preference further includes a personal information export list (contact export entry) according to various embodiments of the present disclosure. The personal information export list includes information on whether the changed personal information is exported to the non-converged address book system, an address of the non-converged address book system to receive and store the changed personal information, and access authentication information of the corresponding non-converged address book system.

Accordingly, when the personal information stored in the CAB XDMS, that is, the converged address book data is changed, the synchronization event processor 321 of the IWF 330 identifies the user preference stored in the CAB XDMS and may identify whether the synchronization event is generated.

When the generation of the synchronization event is identified, the synchronization event processor 321 informs the synchronization personal information configuration unit 322 of the generation of the synchronization event.

The synchronization personal information configuration unit 322 configures synchronization personal information for the synchronization with the non-converged address book system according to a control of the synchronization event processor 321. When the synchronization event is generated according to a converged address book data export request of the user terminal, the synchronization personal information configuration unit 322 obtains personal information to be transmitted to the non-converged address book system from the converged address book data stored in the CAB XDMS. Further, the synchronization personal information configuration unit 322 changes a data format of the obtained personal information into a data format suitable for a data format of the non-converged address book system to be synchronized and then configures synchronization personal information.

If the synchronization event is generated according to the change in the personal information stored in the CAB XDMS, the synchronization personal information configuration unit 322 obtains a personal information export list from the CAB XDMS, changes a data format of the changed personal information, which is to be exported, into a data format supported by the corresponding non-converged address book system according to the obtained personal information export list, and configures the synchronization personal information. At this time, the synchronization personal information configuration unit 322 can report the export of the changed personal information to the CAB XDMS. Through the report, state information indicating whether the synchronization personal information is successfully transferred to the non-converged address book system is managed.

When the format conversion is completed, the synchronization personal information configuration unit 322 transmits the synchronization personal information to the corresponding non-converged address book system.

The above embodiment illustrates that the synchronization event processor 321 and the synchronization personal information configuration unit 322 are included in the IWF 330, but other various embodiments of the present disclosure may construct the synchronization event processor 321 and the synchronization personal information configuration unit 322 separately from the IWF 330 and thus the above operations are performed through interworking with the IWF 330.

FIG. 5 illustrates a construction of a CAB XDMS according to an embodiment of the present disclosure. The CAB XDMS 400 refers to an apparatus for practically storing and managing the personal information managed by the converged address book system, that is, the converged address book data.

Referring to FIG. 5, the CAB XDMS 400 includes a CAB feature handling application usage unit 410, a CAB user preference application usage unit (CAB User Preference Application Usage) 420, a CAB PCC application usage unit (PCC Application Usage) 430, and a CAB address book application usage unit (CAB Address Book Application Usage) 440.

The address book application usage unit 440 stores address information and an address status (contact status).

The CAB PCC application usage unit 430 stores PCC information.

The CAB user preference application usage unit 420 stores and manages the user preference.

The CAB feature handling application usage unit 410 manages various CAB service requests/responses.

The CAB server 400 and the CAB XDMS 500 have been described as separate apparatuses in the above description, but it may be implemented that the CAB server 400 and the CAB XDMS 500 are included in one server apparatus in other various embodiments of the present disclosure.

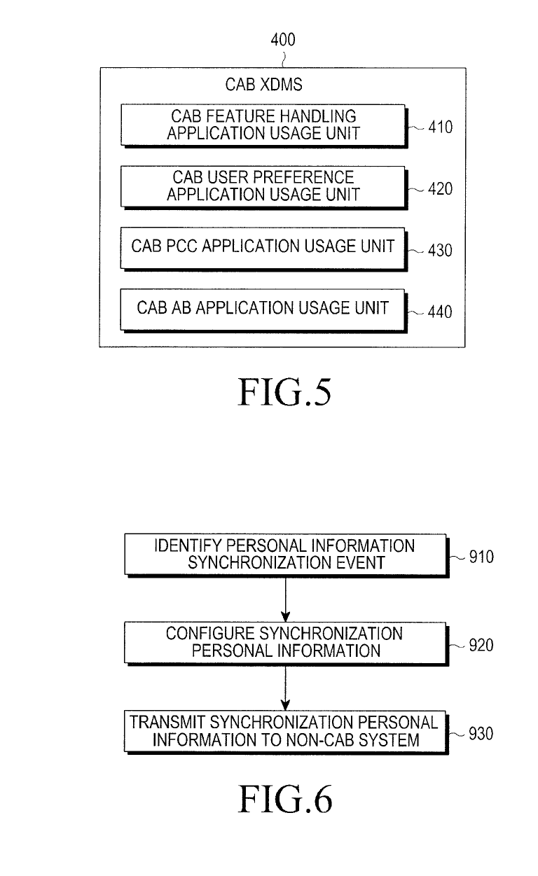

FIG. 6 illustrates a process in which a CAB server synchronizes personal information in a converged address book system, such as the converged address book system described above, according to an embodiment of the present disclosure. Referring to FIG. 6, the CAB server 400 identifies the generation of the personal information synchronization event between the converged address book system and the non-converged address book system at operation 910, the personal information synchronization event being generated in the above various embodiments of the present disclosure. Further, the CAB server 400 configures synchronization personal information to be transmitted to the non-converged address book system according to the generated synchronization event at operation 920 and transmits the configured synchronization personal information to the non-converged address book system at operation 930.

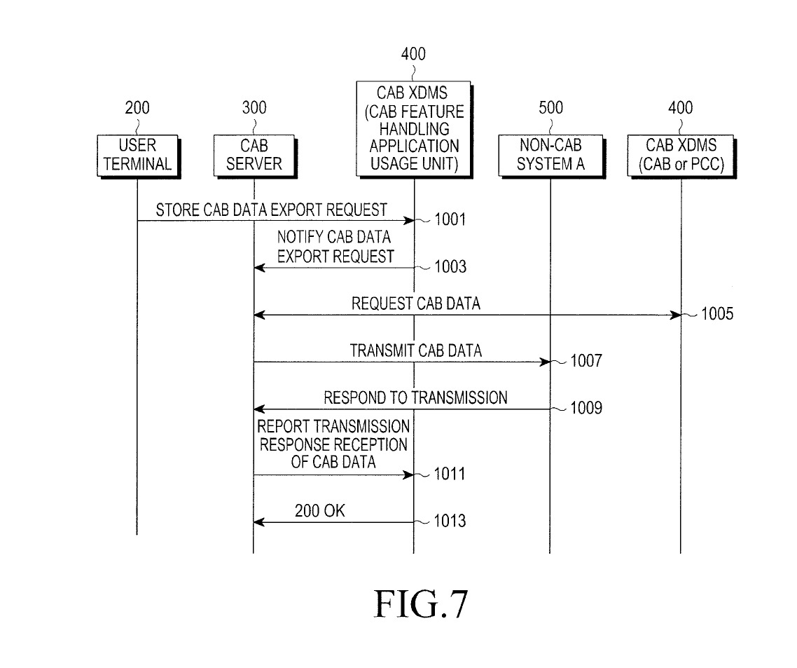

Hereinafter, a process of synchronizing personal information will be described with reference to FIGS. 7, 8, 9, 10, 11, 12, and 13.

FIGS. 7, 8, 9, 10, 11, 12, and 13 illustrate a process of synchronizing CAB personal information according to various embodiments of the present disclosure.

In particular, FIG. 7 illustrates an embodiment of synchronizing address book information by exporting the converged address book data stored in a converged address book system to a non-converged address book system of an external network according to an address book data export request according to an embodiment of the present disclosure.

Referring to FIG. 7, the user terminal 200 generates a request message for a converged address book data export and stores the request message in the CAB feature handling application usage unit 410 of the CAB XDMS 400 at operation 1001. In the embodiment of FIG. 7, it is assumed that the converged address book data is exported to a non-converged address book system A 500.

The request message for the converged address book data export may include an XML Configuration Access Protocol (XCAP) request and an example of the XCAP request is illustrated in Table 1.

```
TABLE 1
    <cab-feature id=“abab1212”>
    <contact-export>
    <non-cab-domain>
    <list>
    <entry_url>“www.facebook.com/joeblogs/profile”</entry_url>
    </list>
    </non-cab-domain>
    <credential>
    <username>joeblogs@example.com</username>
    <password>********</password>
    </credential>
    <interval>0</interval>
    <data>
    <PCC>./cab-address-book/sip:joeblogs@example.com/cab-
pcc/pcc</PCC>
    </data>
    </contact-export>
      </cab-feature>
```

As shown in the schema defined in Table 1, the request message for the non-converged address book data export defines an element <contact-export> as an additional child element of an element <cab-feature> in order to export address book information or PCC information among the converged address book data of the CAB user, and child elements of the element <contact-export> may include an element <non-cab-domain>, an element <credential>, an element <interval>, an element <data>, and an element <filter>. Here, subjects to be exported are limited to the PCC information or the AB information which is the converged address book data, but other personal information, for example, personal/organizational/group contents such as a picture and a dynamic image may be the subjects to be exported.

The element <non-cab-domain> includes address book information of the non-converged address book system to receive the exported converged address book data and the element <credential> includes access authentication information of the corresponding non-converged address book system. Further, the element <data> includes identification information on the converged address book data to be exported, the element <interval> includes information on a time point when the converged address book data, which is to be exported, is exported, and the element <filter> includes a filter limiting information on subjects to be exported.

As described above, when the request message for the address book data export transmitted by the CAB client according to the construction method of the converged address book system is transferred to the CAB server instead of the CAB XDMS, there may exist another type of a protocol, which is not the XCAP, as an interface between the CAB client and the CAB server. In this case, the total schema of the request message for the address book data export may be defined similarly to Table 1.

The CAB feature handling application usage unit 410 of the CAB XDMS 400 adds information contained in the received request message for the converged address book data export to a CAB feature handling document. According to an embodiment of the present disclosure, the element <cab-feature> and child elements of the element <cab-feature> constructed as defined in Table 1 are added to the CAB feature handling document and corresponding information is stored in the CAB feature handling document. Further, an element <response> for identifying whether a personal information synchronization process is normally performed is added to the CAB feature handling document. The element <response> stores information indicating whether the converged address book data to be exported is transferred to the non-converged address book system.

The CAB feature handling application usage unit 410 of the of the CAB XDMS 400 notifies the IWF 330 of the CAB server 300 of a change in the CAB feature handling document at operation 1003. That is, the CAB feature handling application usage unit 410 of the CAB XDMS 400 notifies the IWF 330 of the CAB server 300 that there is the request for the converged address book data export. The CAB server 300 can grasp the change in the CAB feature handling document also through an active polling.

The IWF 330 of the CAB server 300 identifies the generation of the synchronization event according to the request for the address book data export at operation 1005, identifies information included in the request for the converged address book data export, and obtains converged address book data to be exported, that is, address book information or PCC information from the CAB PCC application usage unit 430 or the CAB address book application usage unit 440 of the CAB XDMS 400.

Further, the IWF 330 of the CAB server 300 changes a data format of the obtained converged address book data into a data format suitable for the data format of the corresponding non-converged address book system A 500 based on a data conversion tool such as a data mapping table set in advance, in order to export the obtained converged address book data and then configures synchronization personal information at operation 1007. Furthermore, the IWF 330 of the CAB server 300 configures information indicating the data export for synchronizing the personal information and a message including the synchronization personal information and transmits the configured information and message to the non-converged address book system A 500. Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “pending”.

When the IWF 330 of the CAB server 300 receives a response message to a personal information transmission, that is, a converged address book data transmission from the non-converged address book system A 500 at operation 1009, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1011.

Further, the IWF 330 of the CAB server 300 receives a response message (200 OK) from the CAB XDMS 400 at operation 1013.

When the user terminal 200 additionally desires to identify an export result of the converged address book data, for example, address information or PCC information, the corresponding result may be identified through a change notification according to the subscription for a corresponding document within the CAB feature handling document or an active polling for the corresponding document.

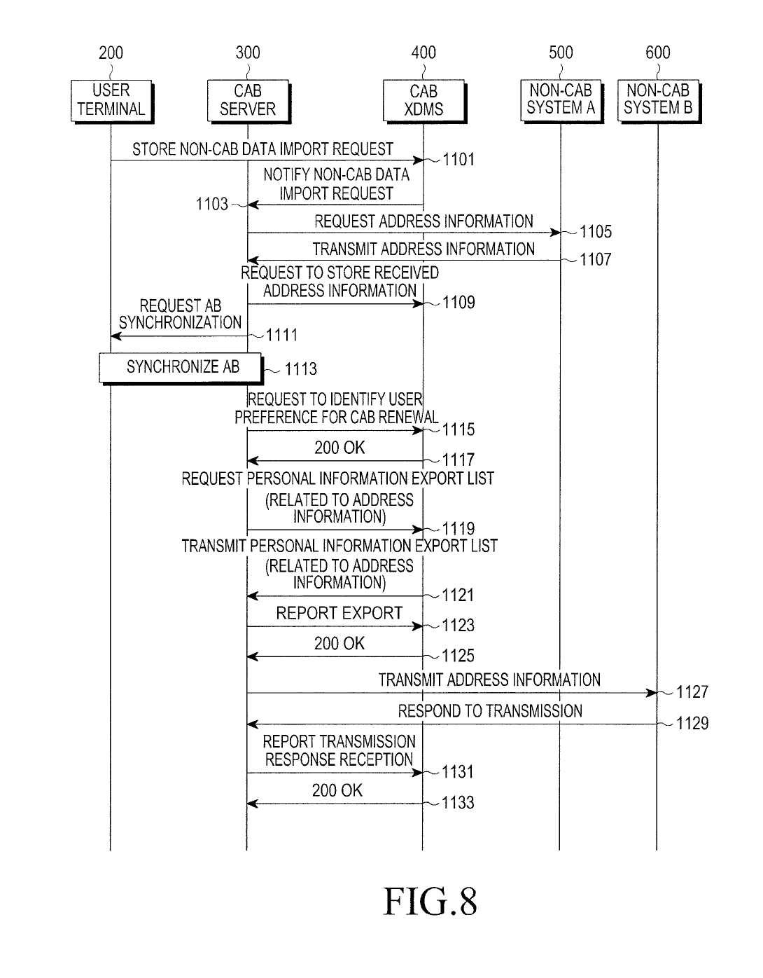

Next, a process for synchronizing personal information with a non-converged address book system B 600 after converged address book data is changed as the converged address book system imports the address information of the non-converged address book system A 500 is described with reference to FIG. 8 according to an embodiment of the present disclosure.

Referring to FIG. 8, the user terminal 200 transmits a request message for an address book import to the CAB feature handling application usage unit 410 of the CAB XDMS 400 in order to import the address book data of the non-converged address book system A 500 at operation 1101. At this time, the request message for the address book import may be implemented in a form of an XCAP request and constructed similarly to Table 1.

As described above, when the request message for the non-converged address book data import transmitted by the CAB client according to the construction method of the converged address book system is transferred to the CAB server instead of the CAB XDMS, there may exist another type of a protocol, which is not the XCAP, as an interface between CAB client and the CAB server. In this case, the total schema of the request message for the non-converged address book data import may be defined similarly to Table 1.

The request message for the address book data import includes an address of the corresponding non-converged address book system, access authentication information of the non-converged address book system, identification information on address book information to be imported, and schedule information on the address book data import. The address book data to be imported may include address book information, profile information, and personal/organizational/group contents and it is assumed that an import of the address book information is requested in various embodiments of FIG. 8.

The CAB feature handling application usage unit 410 of the CAB XDMS 400 adds information included in the request message for the address book data import, that is, the address of the corresponding non-converged address book system, the access authentication information of the corresponding non-converged address book system, and the schedule information on the address book data import to the CAB feature handling document at operation 1103. Further, the CAB feature handling application usage unit 410 of the CAB XDMS 400 notifies that there is a request for the non-converged address book data import by notifying the IWF 330 within the CAB server 300 of a change in the CAB feature handling document. The CAB server 300 of the CAB server 300 can grasp the change in the CAB feature handling document also through an active polling.

The IWF 330 of the CAB server 300 identifies the feature handling document and provides the non-converged address book system A 500 with information required for accessing the non-converged address book of the user terminal 200, that is, the access authentication information, so that the IWF 330 of the CAB server 300 can request address book information at operation 1105. Further, the IWF 330 of the CAB server 300 sets the element <code>, which is a child element of the element <response> of the element <contact-export> of the feature handling document of the CAB feature handling application usage unit 410 of the CAB XDMS 400 as the “pending”.

The IWF 330 of the CAB server 300 receives the address book information requested at operation 1105 from the non-converged address book system A 500 at operation 1107.

Further, the IWF 330 of the CAB server 300 converts the address book information of the user terminal 200 received at operation 1107 to a CAB data format, stores the converted address book information in the address book document of the CAB address book application usage unit 440 of the CAB XDMS 400 according to the user preference, that is, the preference for the address book document renewal according to the data import from the non-converged address book, and then receives a response message from the CAB XDMS at operation 1109.

The address book synchronizer 310 of the CAB server 300 transmits a server-alerted notification to the CAB client 210 of the user terminal 200, so that the address book synchronizer 310 of the CAB server 300 can request the address book synchronization at operation 1111.

The CAB client 210 of the user terminal 200 performs the address book synchronization based on the received server-alerted notification at operation 1113.

When the address book synchronization with the user terminal 200 is completed, the CAB server 300 requests a preference identification for the synchronization of the non-converged address book system to the CAB user preference application usage unit 420 of the CAB XDMS 400 as performed at operation 1115 and receives a response at operation 1117 or may refer to the corresponding preference at operation 1115 based on the CAB user preference pre-obtained at operation 1109. In general, the identification of the user preference at operation 1115 is implemented in the IWF 330 of the CAB server 300 but may be implemented by another function unit of the CAB server 300. In various embodiments of FIG. 8, it is assumed that the user preference is set such that the matters for the address book information renewal of the converged address book data are exported to the non-converged address book system.

The user preference for the address book information export according to an embodiment of the present disclosure is as defined in Table 2.

```
TABLE 2
    <?xml version=“1.0” encoding=“UTF-8”?>
    <cab-upp-set xmlns:ocp=“urn:oma:xml:cab:user-prefs”
    xmlns:xsi=“http://www.w3.org/2001/XMLSchema-instance”>
    <profile id=“abc123”>
    <auto-synchronize-ab> true</auto-synchronize-ab>
    <send-notification-contact-added>faluse</send-notification-contact-
added>
    <receive-notification-when-contact-added>true</receive-notification-
when-contact-added>
    <notify-when-contact-becomes-cab-user>true</notify-when-contact-
becomes-cab-user>
    <notify-when-receive-contact-subscription>true</notify-when-
receive-contact-subscription>
    <notify-on-contact-subscription-update>true</notify-on-contact-
subscription-update>
    <update-ab>true</update-ab>
    <contact-subscription-update>true</contact-subscription-update>
    <import-update>>true</import-update>
    <!preferecne for exporting to non-CAB system initiated by the update
of AB or PCC-->
    <non-cab_system_update>
    <contact-export status=“true”>
    <contact-export-entry index=“abab1212”>
    <non-cab-domain>
    <list>
    <entry_url>“www.facebook.com/joeblogs/address_book”</
    entry_url>
    </list>
    </non-cab-domain>
    <credential>
    <username>joeblogs@example.com</username>
    <password>********</password>
    </credential>
    <interval>0</interval>
    </contact-export-entry>
    </contact-export>
    </non-cab_system_update>
    </profile>
      </cab-upp-set>
```

As shown in the schema defined in Table 2, the CAB user preference application usage unit 440 of the CAB XDMS 400 defines an element <non-cab_system_update> as an additional child element of an element <profile> of a user preference document. The element <non-cab_system_update> refers to an element for storing the user preference for the existence of the synchronization of changed converged address book data and the non-converged address book system when the converged address book data is changed.

The element <non-cab_system_update> has an element <contact-export> as a child element, and the element <contact-export> has “status”, which is a property. The element <contact-export> indicates whether the changed converged address book data is exported. An element <contact-export-entry>, which is a child element of the element <contact-export>, has “index” as a property and may include elements <non-cab-domain>, <credential>, <interval>, and <filter> as child elements.

The element <contact-export-entry> is an element storing a personal information export list and roles of the elements <non-cab-domain>, <credential>, <interval>, and <filter> are as shown in Table 1.

The CAB user preference application usage unit 430 of the CAB XDMS 400 identifies the user preference and informs the IWF 330 of the CAB server 300 of the identified user preference at operation 1117.

Accordingly, the IWF 330 of the CAB server 300 identifies that there is a setting of a synchronization request of the changed converged address book data and the non-converged address book system and generates a synchronization event at operation 1119. That is, the IWF 330 of the CAB server 300 requests the personal information export list to the CAB user preference application usage unit 430 of the CAB XDMS 400 and receives the personal information export list at operation 1121. At this time, it is assumed that the personal information export list is set in connection with the address book information and the non-converged address book system B 600 is set as the non-converged address book system receiving the address book information to be exported.

The IWF 330 of the CAB server 300 generates an export reporting message for reporting the CAB feature handling application usage unit 410 of the CAB XDMS 400 of the converged address book data export based on the personal information export list and transmits the generated export reporting message to the CAB feature handling application usage unit 410 of the CAB XDMS 400 at operation 1123. Table 3 shows an example of the export reporting message.

```
TABLE 3
    <cab-feature id=“cdcd3434”>
    <contact-export>
    <non-cab-domain>
    <list>
    <entry_url>“www.facebook.com/joeblogs/address-book”</
    entry_url>
    </list>
    </non-cab-domain>
    <credential>
    <username>joeblogs@example.com</username>
    <password>********</password>
    </credential>
    <interval>0</interval>
    <data>
    <AB>./cab-address-book/sis:joeblogs@example.com/cab-address-
book/address-book</AB>
    </data>
    </contact-export>
        </cab-feature>
```

Referring to the schema defined in Table 3, it can be seen that the export reporting message is generated based on the personal information export list obtained at operations 1119 to 1121 and the address book information renewed at operations 1101 to 1113.

The CAB server 300 receives a response message (200 OK) from the CAB feature handling application usage unit 410 of the CAB XDMS 400 at operation 1125.

Further, the CAB server 300 converts renewed address book information into a form suitable for a data format of the non-converged address book system B 600 based on a data conversion tool such as a data mapping table set in advance in order to export the changed converged address book data, that is, the renewed address book information and configures synchronization personal information at operation 1127. Further, the CAB server 300 configures information indicating the data export for the personal data synchronization and a message including the synchronization personal information and transmits the configured data and message to the non-converged address book system B 600.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “pending”.

When the IWF 330 of the CAB server 300 receives a response message to a personal information transmission, that is, a converged address book data transmission from the non-converged address book system A 500 at operation 1129, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1131.

Further, the IWF 330 of the CAB server 300 receives a response message (200 OK) from the CAB XDMS 400 at operation 1133.

When the user terminal 200 additionally desires to identify an export result of the converged address book data, for example, address book information or PCC information, the corresponding result may be identified through a change notification according to the subscription for a corresponding document within the CAB feature handling document or an active polling for the corresponding document.

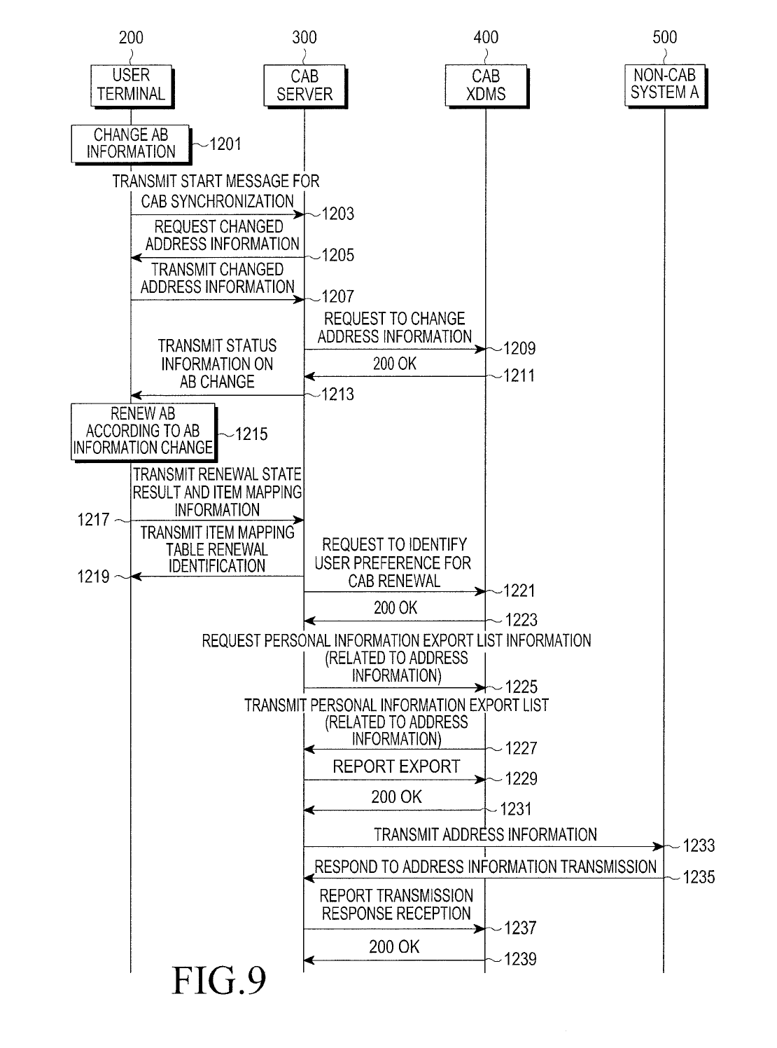

Next, FIG. 9 illustrates an example of a process of a synchronization with the non-converged address book system according to a renewal of the address book document after an address book information synchronization between a terminal address book stored in the user terminal 200 and the address book application usage unit 440 of the CAB XDMS 400 by the CAB user according to an embodiment of the present disclosure.

Referring to FIG. 9, the user terminal 200 starts changing address book information stored in the storage unit 220 of the user terminal 200 according to a user's input at operation 1201.

The CAB client 210 of the user terminal 200 transmits a Data Synchronization (DS) initialization message (Open Mobile Alliance (OMA) DS Pkg #1), which is a message for starting the converged address book synchronization, to the CAB server 300. The DS initialization message includes a synchronization related anchor, that is, a server challenge, terminal capability information, a DS synchronization type, and a data type.

The CAB server 300 generates an authentication challenge response, transmits the generated authentication challenge response in a form of a DS message (OMA DS Pkg #2) to the CAB client 210 of the user terminal 200, and requests changed address book information at operation 1203. The DS message (OMA DS Pkg #2) includes a synchronization related anchor, that is, a server challenge, terminal capability information, a DS synchronization type, and a data type.

The CAB client 210 of the user terminal 200 generates a challenge response, transmits a DS message (OMA DS Pkg #3) including the changed address book information of the terminal to the CAB server 300, and then transmits the changed address book information at operation 1205.

The CAB server 300 analyzes the changed address book information received from the user terminal 200 and makes a request for changing the address book information from the address book application usage unit 430 of the CAB XDMS 400 based on the DS message received at operation 1205 at operation 1207. For example, the CAB server 300 makes a request for adding address book information on “Joe” from the address book application usage unit 440 of the CAB XDMS 400 by using an XCAP protocol. If the DS message includes a plurality of requests for changing the address, a request message for changing the address is generated for each request for changing the address by using the XCAP protocol.

The address book application usage unit 440 of the CAB XDMS 400 transmits the response message (200 OK) to the CAB server 300 at operation 1211. If the address book application usage unit 440 of the CAB XDMS 400 has received one or more XCAP request messages at operation 1207, a response message for each request message is generated and transmitted.

The CAB server 300 transmits a DS message (OMA DS Pkg #4) including status information on the CAB server 300 in connection with the modification of the address book information of the CAB XDMS 400 to the CAB client 210 of the user terminal 200 at operation 1213.

When the CAB client 210 receives the DS message at operation 1213, the CAB client 210 finally renews the address book stored in the storage unit 220 at operation 1215. Further, the CAB client 210 transmits a DS message (OMA DS Pkg #5) including item mapping information between a terminal and a server and a result of the renewed status of the CAB client 210 to the CAB server 300 at operation 1217.

The CAB server 300 transmits a DS message (OMA DS Pkg #6) including a renewal acknowledgement of the item mapping table within the CAB server 300 to the CAB client 210 at operation 1219.

When the address book synchronization between the user terminal 200 and the CAB XDMS 300 is completed according to processes performed at operations 1201 to 1219, the CAB server 300 requests a preference identification for the synchronization of the non-converged address book system to the CAB user preference application usage unit 430 of the CAB XDMS 400 at operation 1221. In various embodiments of FIG. 9, it is assumed that the user preference is set such that the matters for the address book information renewal of the converged address book data are exported to the non-converged address book system.

The CAB user preference application usage unit 430 of the CAB XDMS 400 identifies the user preference and informs the IWF 330 of the CAB server 300 of the identified user preference at operation 1223.

Accordingly, the IWF 330 of the CAB server 300 identifies that the request for the synchronization with the non-converged address book system in connection with the changed converged address book data has been set and generates the synchronization event at operation 1225. That is, the IWF 330 of the CAB server 300 requests the personal information export list to the CAB user preference application usage unit 430 of the CAB XDMS 400 and receives the request personal information export list at operation 1227. At this time, it is assumed that the personal information export list is set in connection with the address book information and the non-converged address book system A 500 is set as the non-converged address book system receiving the address book information to be exported.

The IWF 330 of the CAB server 300 generates an export reporting message for reporting the CAB feature handling application usage unit 410 of the CAB XDMS 400 of the converged address book data export based on the personal information export list and transmits the generated export reporting message to the CAB feature handling application usage unit 410 of the CAB XDMS 400 at operation 1229. The export reporting message is generated based on the personal information export list and newly added address book information obtained at operations 1207 and 1227.

The CAB server 300 receives the response message (200 OK) from the CAB feature handling application usage unit 410 of the CAB XDMS 400 at operation 1231.

Further, the CAB server 300 converts renewed address book information to a form suitable for a data format of the non-converged address book system A 500 based on a data conversion tool such as a data mapping table set in advance in order to export the changed converged address book data, that is, the renewed address book information and configures synchronization personal information at operation 1233. Further, the CAB server 300 configures information indicating the data export for the personal data synchronization and a message including the synchronization personal information and transmits the configured data and message to the non-converged address book system A 500.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “padding”.

When the IWF 330 of the CAB server 300 receives a response message to a personal information transmission, that is, a converged address book data transmission from the non-converged address book system A 500 at operation 1235, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1237.

Further, the IWF 330 of the CAB server 300 receives a response message (200 OK) from the CAB XDMS 400 at operation 1239.

When the user terminal 200 additionally desires to identify an export result of the converged address book data, for example, address book information or PCC information, the corresponding result may be identified through a change notification according to the subscription for a corresponding document within the CAB feature handling document or an active polling for the corresponding document.

For reference, it is preferable that operations 1209 and 1211 have been completed before the completion of the data synchronization, that is, operation 1213 or 1219 in order to prevent the data inconsistency.

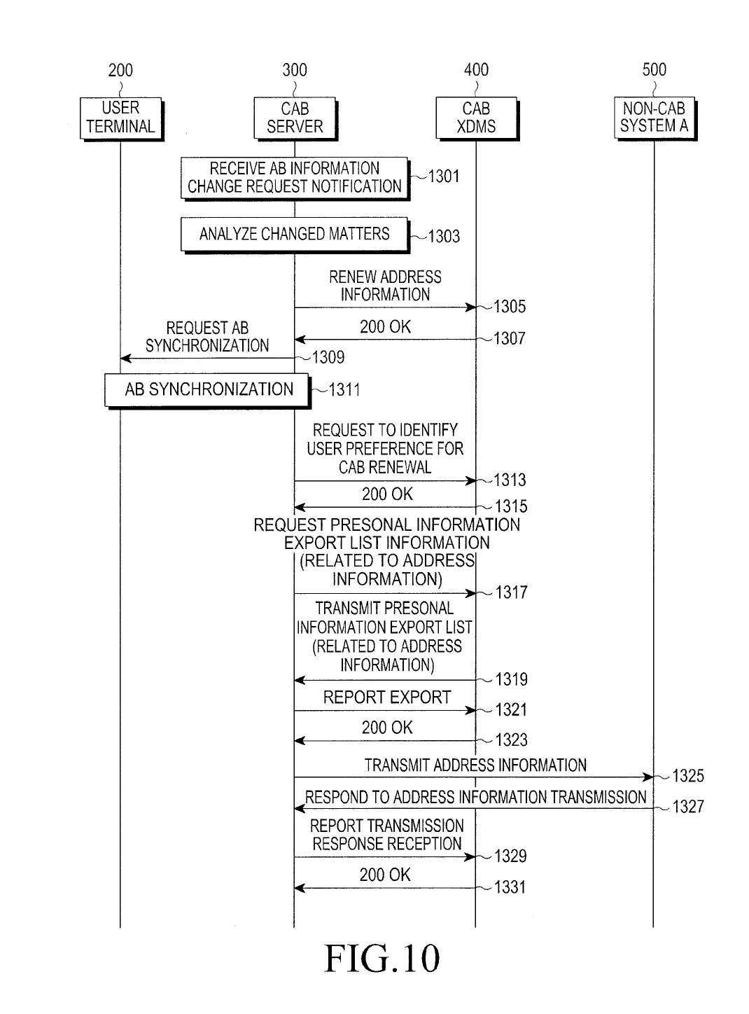

FIG. 10 illustrates an example in which the network instead of the user terminal 200 requests a change in address book information according to an embodiment of the present disclosure. Specifically, FIG. 10 shows a process for synchronizing a renewed address book document with an additional non-converged address book system when it is required to renew an address book document of a user according to a change in a PCC document of a specific user terminal or a specific user subscribing the address book. The PCC document refers to a document storing PCC information.

Referring to FIG. 10, the CAB server 300 receives a notification message for requesting a change in the address book document corresponding to the user terminal 200 from the network entity at operation 1301. For example, the user terminal 200 may receive a notification according to a change in the PCC document of the specific user terminal subscribing the address book.

The CAB server 300 analyzes changes included in the notification message received at operation 1301 and identifies that the PCC information of the specific user terminal has been changed at operation 1303. Accordingly, the CAB server 300 renews the address book document of the user terminal 200 stored in the CAB XDMS 400 based on the changed PCC information at operation 1305 and receives the response message (200 OK) from the address book application usage unit 400 at operation 1307.

The address book synchronizer 310 of the CAB server 300 transmits a server-alerted notification to the CAB client 210 of the user terminal 200 and then requests the address book synchronization at operation 1309.

The CAB client 210 of the user terminal 200 synchronizes address book information stored in the user terminal 200 with address book information of the user terminal 200 stored in the CAB XDMS 400 based on the received server-alerted notification at operation 1311.

When the synchronization with the user terminal 200 is completed, the CAB server 300 requests a preference identification for the synchronization of the non-converged address book system to the CAB user preference application usage unit 430 of the CAB XDMS 400 at operation 1313. In various embodiments of FIG. 10, it is assumed that the user preference is set such that matters renewed from the address book information of the converged address book data are exported to the non-converged address book system.

The CAB user preference application usage unit 430 of the CAB XDMS 400 identifies the user preference and informs the IWF 330 of the CAB server 300 of the identified user preference at operation 1315.

Accordingly, the IWF 330 of the CAB server 300 identifies that there is a setting of a synchronization request of the changed converged address book data and the non-converged address book system and generates a synchronization event at operation 1317. That is, the IWF 330 of the CAB server 300 requests the personal information export list to the CAB user preference application usage unit 430 of the CAB XDMS 400 and receives the personal information export list at operation 1319. At this time, it is assumed that the personal information export list is set in connection with the address book information and the non-converged address book system A 500 is set as the non-converged address book system receiving the address book information to be exported.

The IWF 330 of the CAB server 300 generates an export reporting message for reporting the CAB feature handling application usage unit 410 of the CAB XDMS 400 of the converged address book data export based on the personal information export list and transmits the generated export reporting message to the CAB feature handling application usage unit 410 of the CAB XDMS 400 at operation 1321. The export reporting message is generated based on newly added address book information at operations 1301 to 1307 and the personal information export list obtained at operations 1317 to 1319.

The CAB server 300 receives the response message (200 OK) from the CAB feature handling application usage unit 410 of the CAB XDMS 400 at operation 1323.

Further, the CAB server 300 converts renewed address book information to a form suitable for a data format of the non-converged address book system A 500 based on a data conversion tool such as a data mapping table set in advance in order to export the changed converged address book data, that is, the renewed address book information and configures synchronization personal information at operation 1325. Further, the CAB server 300 configures information indicating the data export for the personal data synchronization and a message including the synchronization personal information and transmits the configured data and message to the non-converged address book system A 500.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “padding”.

When the IWF 330 of the CAB server 300 receives a response message to a personal information transmission, that is, a converged address book data transmission from the non-converged address book system A 500 at operation 1327, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1329.

Further, the IWF 330 of the CAB server 300 receives a response message (200 OK) from the CAB XDMS 400 of the CAB XDMS 400 at operation 1331.

When the user terminal 200 additionally desires to identify an export result of the converged address book data, for example, address book information or PCC information, the corresponding result may be identified through a change notification according to the subscription for a corresponding document within the CAB feature handling document or an active polling for the corresponding document.

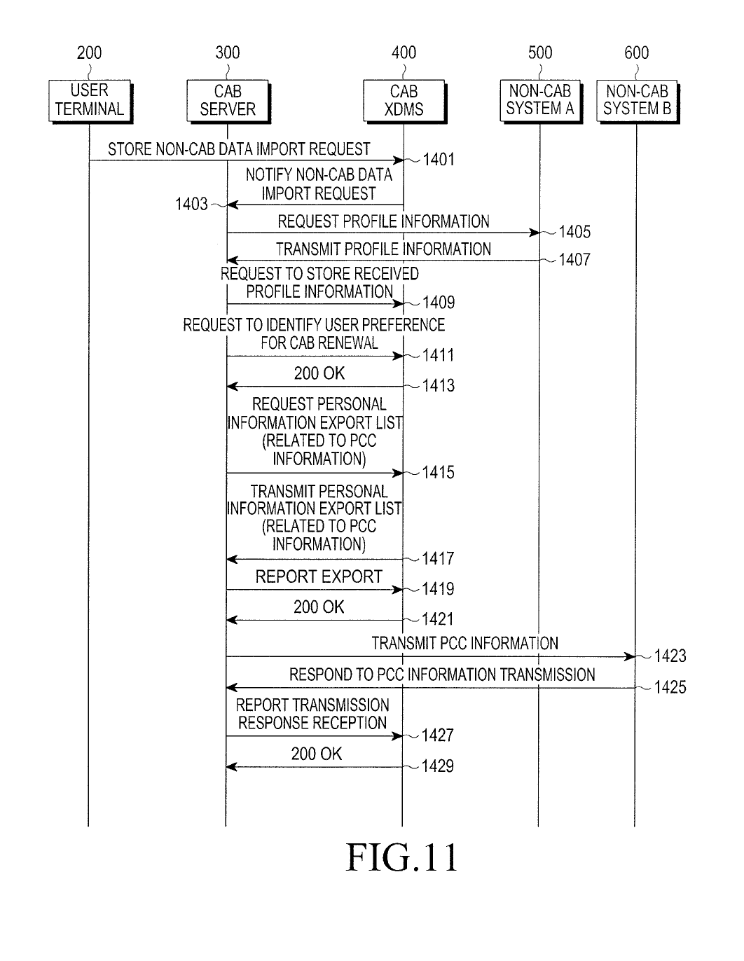

FIG. 11 illustrates a process of importing profile information from the non-converged address book system and then synchronizing the profile information with another non-converged address book system by the CAB user according to an embodiment of the present disclosure. Through the process, the CAB user can efficiently manage personal information through synchronizing a PCC document of the CAB user with a plurality of profile information stored in the non-converged address book system. In various embodiments of FIG. 11, it is assumed that profile information is imported from the non-converged address book system A 500, PCC information of the converged address book data is renewed, and then the profile information of the non-converged address book system B 600 and the renewed PCC information are synchronized.

Referring to FIG. 11, the CAB client 210 of the user terminal 200 configures a request message for the non-converged address book data import for requesting the non-converged address book data import in a form of an XCAP request and transmits the configured request message to the CAB feature handling application usage unit 410 of the CAB XDMS 400 at operation 1401. At this time, the request message for the non-converged address book import is a message for requesting an import of the profile information among the non-converged address book data and an example of this is shown in Table 4.

TABLE 4

<cab-feature id=“efef5656”>
<import-non-cab>
<non-cab-source>
<list>
<entry_url>“www.facebook.com/joeblogs/profile”</entry_url>
</list>
</non-cab-source>
<credential>
<username>joeblogs@example.com</username>
<password>********</password>
</credential>
<interval>0</interval>
</import-non-cab>
</cab-feature>

As shown in the schema defined in Table 4, the XCAP request extends a subject of an import of an element <import-non-cab> to personal/organizational/group content information (e.g., picture, video, contents, etc.) or profile information of the external network from address book data of the related-art external network in order to bring profile information stored in the external network of the CAB user to an inside of the converged address book system.

As described above, when the request message for the non-converged address book data import transmitted by the CAB client according to the construction method of the converged address book system is transferred to the CAB server instead of the CAB XDMS, there may exist another type of a protocol, which is not the XCAP, as an interface between the CAB client and the CAB server. In this case, the total schema of the request message for the address book data import may be defined similarly to Table 4.

The CAB feature handling application usage unit 410 of the CAB XDMS 400 adds information included in the request message for the address book data import, that is, the address of the corresponding non-converged address book system, the access authentication information of the corresponding non-converged address book system, and the schedule information on the address book data import to the CAB feature handling document, and notifies the IWF 320 of the CAB server 300 of a change in the CAB feature handling document at operation 1403. At this time, it is assumed that the request message for the non-converged address book import includes a request for importing the profile information from the non-converged address book system A 500.

The IWF 330 of the CAB server 300 identifies the feature handling document, provides information required for accessing the non-converged address book of the user terminal 200, that is, the access authentication information to the non-converged address book system A 500, and requests profile information at operation 1405. Further, the IWF 330 of the CAB server 300 sets an element <code>, which is a child element of an element <response> of an element <import-non-cab> of the feature handling document of the CAB feature handling application usage unit 410 of the CAB XDMS 400, as a “pending” at operation 1405.

The IWF 330 of the CAB server 300 obtains profile information designated by the user among the non-converged address book system A 500 corresponding to the user terminal 200 from the non-converged address book system A 500 at operation 1407.

Further, the IWF 330 of the CAB server 300 converts the obtained profile information of the user to a CAB data format, stores the converted profile information in the PCC document of the CAB PCC application usage unit 430 of the CAB XDMS 400 according to the CAB user preference, that is, the preference for the renewal of the PCC document in accordance with the data import from the non-converged address book, and then receives a response message at operation 1409.

The CAB server 300 requests a preference identification for the synchronization of the non-converged address book system to the CAB user preference application usage unit 420 of the CAB XDMS 400 at operation 1411 and receives a response at operation 1413 or may refer to the corresponding preference at operation 1411 based on the CAB user preference pre-obtained at operation 1409. At this time, the element <contact-export> is referred as the preference for the synchronization of the non-converged address book system among the CAB user preference. In various embodiments of FIG. 11, it is further extended that the CAB user address book document is automatically renewed in connection with imported address book information of the non-converged address book system in the various embodiments of FIG. 8. Further, the converged address book system can not only automatically renew the PCC document but also maintain and manage matters for personal/organizational/group contents of a non-converged address book system. Accordingly, it is preferable that the CAB user preference also includes the preference related to the automatic renewal for the PCC information or the personal/organizational/group contents.

In general, the user preference is identified by the IWF 330 of the CAB server 300 as shown at operation 1411, but other function units of the CAB server 300 may identify the user preference. Further, in various embodiments of FIG. 11, it is assumed that the user preference is set such that matters renewed from the address book information of the converged address book data are exported to the non-converged address book system.

The user preference for exporting the PCC information according to an embodiment of the present disclosure is illustrated in Table 5.

```
TABLE 5
    <?xml version=“1.0” encoding=“UTF-8”?>
    <cab-upp-set xmlns:ocp=“urn:oma:xml:cab:user-prefs”
    xmlns:xsi=“http://www.w3.org/2001/XMLSchema-instance”>
    <profile id=“abc123”>
    <auto-synchronize-ab> true</auto-synchronize-ab>
    <send-notification-contact-added>faluse</send-notification-contact-
added>
    <receive-notification-when-contact-added>true</receive-notification-
when-contact-added>
    <notify-when-contact-becomes-cab-user>true</notify-when-contact-
becomes-cab-user>
    <notify-when-receive-contact-subscription>true</notify-when-
receive-contact-subscription>
    <notify-on-contact-subscription-update>true</notify-on-contact-
subscription-update>
    <update-ab>true</update-ab>
    <contact-subscription-update>true</contact-subscription-update>
    <import-update>true</import-update>
    <!preferecne for exporting to non-CAB system initiated by the update
of AB or PCC-->
    <non-cab_system_update>
    <contact-export status=“true”>
    <contact-export-entry index=“ghgh7878”>
    <non-cab-domain>
        <list>
      <entry_url>“www.facebook.com/joeblogs/profile”</entry_url>
    </list>
    </non-cab-domain>
      <credential>
    <username>joeblogs@example.com</username>
    <password>********</password>
    </credential>
    <interval>0</interval>
    </contact-export-entry>
    </contact-export>
    </non-cab_system_update>
    </profile>
      </cab-upp-set>
```

As shown in the schema defined in Table 5, the user preference of Table 5 is similar to the user preference of Table 2. However, since the user preference of Table 5 requires information for exporting profile information, that is, PCC information instead of address book information, a subject of the element <non-cab-domain> is the profile information of the non-converged address book system of the CAB user.

The CAB user preference application usage unit 430 of the CAB XDMS 400 identifies the user preference and informs the IWF 330 of the CAB server 300 of the identified user preference at operation 1413.

Accordingly, the IWF 330 of the CAB server 300 identifies that a request for the synchronization between changed converged address book data and the non-converged address book system has been set and generates a synchronization event at operation 1415. That is, the IWF 330 of the CAB server 300 requests a personal information export list to the CAB user preference application usage unit 430 of the CAB XDMS 400 and receives the requested personal information export list at operation 1417. At this time, it is assumed that the personal information export list is set in connection with the PCC information and the non-converged address book system B 600 is set as the non-converged address book system receiving the PCC information, that is, the profile information.

The IWF 330 of the CAB server 300 generates an export reporting message for reporting the converged address book data export to the CAB feature handling application usage unit 410 of the CAB XDMS 400 based on the personal information export list and transmits the generated export reporting message to the CAB feature handling application usage unit 410 of the CAB XDMS 400 at operation 1419. Table 6 shows an example of the export reporting message.

```
TABLE 6
    <cab-feature id=“cdcd3434”>
    <contact-export>
    <non-cab-domain>
    <list>
    <entry_url>“www.facebook.com/joeblogs/profile”</entry_url>
    </list>
    </non-cab-domain>
    <credential>
    <username>joeblogs@example.com</username>
    <password>********</password>
    </credential>
    <interval>0</interval>
    <data>
    <PCC>./cab-address-book/sip:joeblogs@example.com/cab-
pcc/pcc</PCC>
    </data>
    </contact-export>
      </cab-feature>
```

Referring to the schema defined in Table 6, it can be seen that the export reporting message is generated based on the personal information export list obtained at operations 1415 to 1417 and the PCC information renewed at operations 1401 to 1409.

The CAB server 300 receives a response message (200 OK) from the CAB feature handling application usage unit 410 of the CAB XDMS 400 at operation 1421.

Further, the CAB server 300 converts the renewed PCC information to a form suitable for a data format of the non-converged address book system B 600 based on a data conversion tool such as a data mapping table set in advance in order to export the changed converged address book data, that is, the renewed PCC information and configures synchronization personal information at operation 1423. Further, the CAB server 300 configures information indicating the data export for the personal data synchronization and a message including the synchronization personal information and transmits the configured data and message to the non-converged address book system B 600.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “pending”.

When the IWF 330 of the CAB server 300 receives a response message to a personal information transmission, that is, a PCC information transmission from the non-converged address book system B 600 at operation 1425, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1427.

Further, the IWF 330 of the CAB server 300 receives a response message (200 OK) from the CAB XDMS 400 at operation 1429.

When the CAB client 210 of the user terminal 200 additionally desires to identify a result of the synchronization with the non-converged address book system B 600 according to the profile information import from the non-converged address book system A 500, the corresponding result may be identified through a change notification according to the subscription for a corresponding document within the CAB feature handling document or an active polling for the corresponding document.

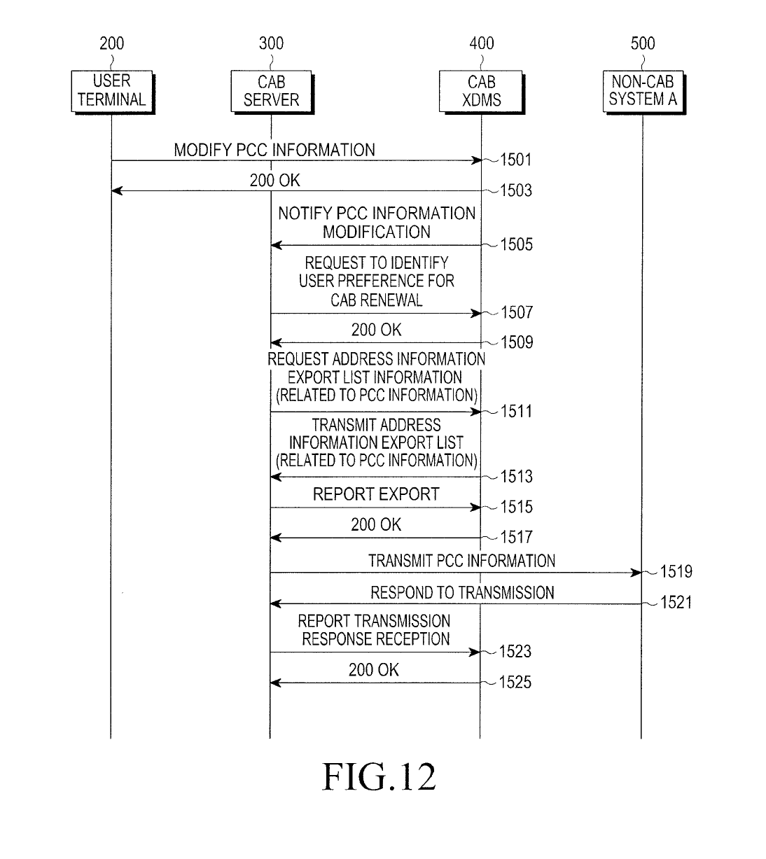

FIG. 12 illustrates an example of a process of synchronizing changed matters of PCC information of the CAB user with another non-converged address book system by the CAB user according to an embodiment of the present disclosure.

Referring to FIG. 12, the CAB client 210 of the user terminal 200 modifies PCC information included in a PCC document stored in the PCC application usage unit 430 of the CAB XDMS 400 at operation 1501.

After the modification is completed, the CAB client 210 of the user terminal 200 receives a response message (200 OK) from the PCC application usage unit 430 of the CAB XDMS 400 at operation 1503.

The PCC application usage unit 430 of the CAB XDMS 400 notifies the CAB server 300 of changed matters of the PCC document at operation 1505. Further, the CAB server 300 can grasp the change in the CAB feature handling document through a PCC document manage mentor a document subscription/notification on a regular period.

The CAB server 300 requests the preference identification for the synchronization of the non-converged address book system to the CAB user preference application usage unit 420 of the CAB XDMS 400 at operation 1507. In general, the identification of the user preference as performed at operation 1507 is implemented in the IWF 330 of the CAB server 300 but may be implemented by another function unit of the CAB server 300. In various embodiments of FIG. 12, it is assumed that the user preference is set such that the matters about the renewed PCC information of the converged address book data are exported to the non-converged address book system.

The CAB user preference application usage unit 430 of the CAB XDMS 400 identifies the user preference and informs the IWF 330 of the CAB server 300 of the identified user preference (200 OK) at operation 1509.

Accordingly, the IWF 330 of the CAB server 300 identifies that a request for the synchronization between changed converged address book data and the non-converged address book system has been set and generates a synchronization event at operation 1511. That is, the IWF 330 of the CAB server 300 requests a personal information export list to the CAB user preference application usage unit 430 of the CAB XDMS 400 and receives the requested personal information export list at operation 1513. At this time, it is assumed that the personal information export list is set in connection with the PCC information and the non-converged address book system A 500 is set as the non-converged address book system receiving the PCC information to be exported.

The IWF 330 of the CAB server 300 generates an export reporting message for reporting the CAB feature handling application usage unit 410 of the CAB XDMS 400 of the converged address book data export based on the personal information export list and transmits the generated export reporting message to the CAB feature handling application usage unit 410 of the CAB XDMS 400 at operation 1515. Table 6 shows an example of the export reporting message. The export reporting message is generated based on the personal information export list obtained at operations 1511 to 1513 and the PCC information changed at operations 1501 to 1505.

The CAB server 300 receives the response message (200 OK) from the CAB feature handling application usage unit 410 of the CAB XDMS 400 at operation 1517.

Further, the CAB server 300 converts the changed PCC information to a form suitable for a data format of the non-converged address book system A 500 based on a data conversion tool such as a data mapping table set in advance in order to export the changed converged address book data, that is, the changed PCC information and configures synchronization personal information at operation 1519. Further, the CAB server 300 configures information indicating the data export for the personal data synchronization and a message including the synchronization personal information and transmits the configured data and message to the non-converged address book system A 500.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “pending”.

When the IWF 330 of the CAB server 300 receives a response message to a personal information transmission, that is, a PCC information transmission from the non-converged address book system A 500 at operation 1521, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1523.

Further, the IWF 330 of the CAB server 300 receives a response message (200 OK) from the CAB XDMS 400 at operation 1525.

When the CAB client 210 of the user terminal 200 additionally desires to identify a result of the synchronization with the non-converged address book system B 600 according to the change in the PCC document, the corresponding result may be identified through a change notification according to the subscription for a corresponding document within the CAB feature handling document or an active polling for the corresponding document.

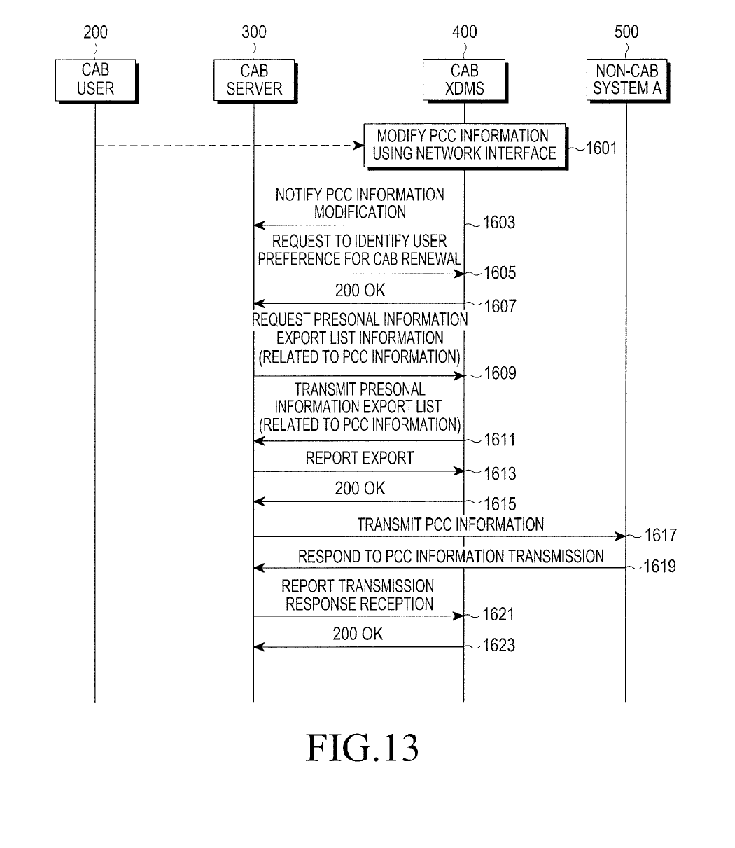

FIG. 13 illustrates a process of the synchronization with another non-converged address book system when a PCC document of the CAB user is changed by a network interface such as an API (Application Program Interface) according to an embodiment of the present disclosure.

Referring to FIG. 13, the CAB user modifies a PCC document stored in the PCC application usage unit 430 of the CAB XDMS 400 by using the network interface at operation 1601. Here, it is assumed that an authentication and an access rule related to the access of the PCC document are not allowed for the corresponding network interface and the CAB user modifies the PCC information by using a network interface exposed to an outside by the non-converged address book system

The PCC application usage unit 430 of the CAB XDMS 400 notifies the CAB server 300 of changed matters of the PCC document at operation 1603. Further, the CAB server 300 can grasp the change in the CAB feature handling document through a PCC document management or a document subscription/notification on a regular period.

The CAB server 300 requests the preference identification for the synchronization of the non-converged address book system to the CAB user preference application usage unit 420 of the CAB XDMS 400 at operation 1605. In general, the identification of the user preference is implemented in the IWF 330 of the CAB server 300 but may be implemented by another function unit of the CAB server 300. In various embodiments of FIG. 13, it is assumed that the user preference is set such that the matters about renewed matters of the PCC information of the converged address book data are exported to the non-converged address book system.

The CAB user preference application usage unit 430 of the CAB XDMS 400 identifies the user preference and informs the IWF 330 of the CAB server 300 of the identified user preference at operation 1607. Accordingly, the IWF 330 of the CAB server 300 identifies that a request for the synchronization between changed converged address book data and the non-converged address book system has been set and generates a synchronization event at operation 1609. That is, the IWF 330 of the CAB server 300 requests a personal information export list to the CAB user preference application usage unit 430 of the CAB XDMS 400 and receives the requested personal information export list at operation 1611. At this time, it is assumed that the personal information export list is set in connection with the PCC information and the non-converged address book system A 500 is set as the non-converged address book system receiving the PCC information to be exported.

The IWF 330 of the CAB server 300 generates an export reporting message for reporting the converged address book data export to the CAB feature handling application usage unit 410 of the CAB XDMS 400 based on the personal information export list and transmits the generated export reporting message to the CAB feature handling application usage unit 410 of the CAB XDMS 400 at operation 1613. The export reporting message is generated based on the personal information export list obtained at operations 1607 to 1609 and the PCC information changed at operation 1601.

The CAB server 300 receives the response message (200 OK) from the CAB feature handling application usage unit 410 of the CAB XDMS 400 at operation 1615.

Further, the CAB server 300 converts the changed PCC information to a form suitable for a data format of the non-converged address book system A 500 based on a data conversion tool such as a data mapping table set in advance in order to export the changed converged address book data, that is, the changed PCC information and configures synchronization personal information at operation 1617. Further, the CAB server 300 configures information indicating the data export for the personal data synchronization and a message including the synchronization personal information and transmits the configured data and message to the non-converged address book system A 500.

Thereafter, the IWF 330 of the CAB server 300 sets an element <code>, which is a child element within the element <response> of the element <contact-export> of the CAB feature handling document of the CAB feature handling application usage unit 410 of the CAB XDMS 400, as a “pending”.

When the IWF 330 of the CAB server 300 receives a response message to a personal information transmission, that is, a PCC information transmission from the non-converged address book system A 500 at operation 1619, the IWF 330 of the CAB server 300 reports a transmission response reception to the CAB feature handling application usage unit 410 of the CAB XDMS 400 and renews the element <response> of the CAB feature handling document as a corresponding information transmission completion at operation 1621.

Further, the IWF 330 of the CAB server 300 receives a response message (200 OK) from the CAB XDMS 400 at operation 1623.

When the CAB client 210 of the user terminal 200 additionally desires to identify a result of the synchronization with the non-converged address book system B 600 according to the change in the PCC document, the corresponding result may be identified through a change notification according to the subscription for a corresponding document within the CAB feature handling document or an active polling for the corresponding document.

The converged address book system, which should perform an operation for the document stored in the CAB XDMS 400 by using the CAB feature application usage unit 410 of the CAB XDMS 400 because the CAB client 210 of the user terminal 200 cannot directly access the CAB server 300, can be operated as proposed in the listed various embodiments. A different converged address book system from the above mentioned system can be operated as proposed in the listed various embodiments through directly exchanging the request/response message between the CAB client and the CAB server as described above even when the address book synchronization performed between the CAB client and the CAB XDMS is implemented using an SIP event package. The above listed various embodiments make some modifications in the operation method, the message type, and the operation order without departing from the scope of the functional implementation of an XDM document, but the modified method and the operation interpreted in the whole context may be considered to be included in the same scope of the present disclosure.

As described above, it is possible to efficiently manage personal information by synchronizing address book data stored in the converged address book system with personal information stored in a plurality of non-converged address book systems through the export of personal information such as address book information or PCC information from the converged address book system by the CAB user.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of synchronizing converged address book personal information managed by a converged address book system with non-converged address book personal information managed by a non-converged address book system, which does not support a converged address book service, by a server apparatus supporting the converged address book service, the method comprising:
identifying a generation of a synchronization event for urging a synchronization between converged address book personal information corresponding to a user terminal and non-converged address book personal information corresponding to the user terminal;
configuring synchronization personal information including at least a part of the converged address book personal information; and
exporting the synchronization personal information to a non-converged address book system related to the user terminal.

2. The method as claimed in claim 1, wherein the synchronization event is generated by an export request message for requesting to transmit the converged address book personal information to the non-converged address book system, the export request message being transmitted by the user terminal.

3. The method as claimed in claim 2, wherein the export request message includes an address of the non-converged address book system, access authentication information of the non-converged address book system, and identification information on the converged address book personal information to be exported.

4. The method as claimed in claim 3, wherein the configuring of the synchronization personal information includes to converting a data format of the converged address book personal information, which is to be exported, to a data format supported by the non-converged address book system.

5. The method as claimed in claim 1, wherein, when a synchronization request for requesting to export changed converged address book personal information to the non-converged address book system is set in a user preference stored for the user terminal and the converged address book personal information corresponding to the user terminal is changed, the synchronization event is generated.

6. The method as claimed in claim 5, wherein the configuring of the synchronization personal information comprises:
obtaining a personal information export list included in the user preference; and
converting a data format of the changed converged address book personal information to a data format of the non-converged address book system designated by the personal information export list,
wherein the synchronization personal information is exported to the non-converged address book system.

7. The method as claimed in claim 6, wherein status information on whether the synchronization personal information is successfully exported to the non-converged address book system is managed.

8. The method as claimed in claim 7, further comprising transmitting the status information on whether the synchronization personal information is exported to the non-converged address book system to the user terminal.

9. The method as claimed in claim 6, wherein the identifying of the generation of the synchronization event comprises:
obtaining specific non-converged address book personal information designated by an import request message transmitted from the user terminal from a specific non-converged address book system;
storing the specific non-converged address book personal information as the converged address book personal information corresponding to the user terminal;
identifying whether the synchronization request is set in the user preference; and
identifying the generation of the synchronization event when the synchronization request is set.

10. The method as claimed in claim 6, wherein identifying of the generation of the synchronization event comprises:
changing the converged address book personal information stored in a server for the user terminal according to a change in address book personal information stored in the user terminal;
identifying whether the synchronization request is set in the user preference; and
identifying the generation of the synchronization event when the synchronization request is set.

11. The method as claimed in claim 6, wherein identifying of the generation of the synchronization event comprises:
changing the converged address book personal information through a network interface;
identifying whether the synchronization request is set in the user preference; and
identifying the generation of the synchronization event when the synchronization request is set.

12. A server apparatus for supporting a converged address book service and synchronizing converged address book personal information managed by a converged address book system with non-converged address book personal information managed by a non-converged address book system, which does not support the converged address book service, the server apparatus comprising:
a synchronization event processor configured to identify a generation of a synchronization event for urging a synchronization between converged address book personal information corresponding to a user terminal and non-converged address book personal information corresponding to the user terminal; and
a synchronization personal information configuration unit configured to configure synchronization personal information including at least a part of the converged address book personal information and exporting the synchronization personal information to a non-converged address book system related to the user terminal

13. The server apparatus as claimed in claim 12, wherein the synchronization event is generated by an export request message for requesting to transmit the converged address book personal information to the non-converged address book system, the export request message being transmitted by the user terminal.

14. The server apparatus as claimed in claim 13, wherein the export request message includes an address of the non-converged address book system, access authentication information of the non-converged address book system, and identification information on the converged address book personal information to be exported.

15. The server apparatus as claimed in claim 14, wherein the synchronization personal information configuration unit converts a data format of the converged address book personal information, which is to be exported, to a data format supported by the non-converged address book system.

16. The server apparatus as claimed in claim 12, wherein, in a case where a synchronization request for requesting to export changed converged address book personal information to the non-converged address book system is set in a user preference stored for the user terminal and the converged address book personal information corresponding to the user terminal is changed, the synchronization event is generated.

17. The server apparatus as claimed in claim 16, wherein the synchronization personal information configuration unit obtains a personal information export list included in the user preference, converts a data format of the changed converged address book personal information to a data format of the non-converged address book system designated by the personal information export list, and exports the synchronization personal information to the non-converged address book system.

18. The server apparatus as claimed in claim 17, wherein the synchronization personal information configuration unit manages status information on whether the synchronization personal information is successfully exported to the non-converged address book system.

19. The server apparatus as claimed in claim 18, wherein the status information on whether the synchronization personal information is exported to the non-converged address book system is transmitted to the user terminal

20. The server apparatus as claimed in claim 17, wherein the synchronization event processor obtains specific non-converged address book personal information designated by an import request message transmitted from the user terminal from a specific non-converged address book system, stores the specific non-converged address book personal information as the converged address book personal information corresponding to the user terminal, identifies whether the synchronization request is set in the user preference, and identifies the generation of the synchronization event when the synchronization request is set.

21. The server apparatus as claimed in claim 17, wherein, when the converged address book personal information stored in a server for the user terminal is changed according to a change in address book personal information stored in the user terminal, the synchronization event processor identifies whether the synchronization request is set in the user preference and identifies the generation of the synchronization event when the synchronization request is set.

22. The server apparatus as claimed in claim 17, wherein, when the converged address book personal information is changed through a network interface, the synchronization event processor identifies whether the synchronization request is set in the user preference and identifies the generation of the synchronization event when the synchronization request is set.

23. A method of synchronizing converged address book personal information managed by a converged address book system with non-converged address book personal information managed by a non-converged address book system, which does not support a converged address book service, by a user terminal supporting the converged address book service, the method comprising:
configuring an export request message for requesting to export at least a part of converged address book personal information stored in a server apparatus for the user terminal to a non-converged address book system; and
transmitting the export request message to the server apparatus,
wherein the export request message includes an address of the non-converged address book system, access authentication information of the non-converged address book system, and identification information on the converged address book personal information to be exported.

24. The method as claimed in claim 23, further comprising, setting a synchronization request for requesting to export changed converged address book personal information to the non-converged address book system in a user preference stored in the server apparatus for the user terminal when the converged address book personal information corresponding to the user terminal is changed.

25. The method as claimed in claim 24, further comprising receiving information on whether the converged address book personal information to be exported or the changed converged address book personal information is exported to the non-converged address book system.

26. A user terminal for supporting a converged address book service and synchronizing converged address book personal information managed by a converged address book system with non-converged address book personal information managed by a non-converged address book system, which does not support the converged address book service, the user terminal comprising:
a transceiver configured for one of transmitting data to and receiving data from a server apparatus storing converged address book personal information corresponding to the user terminal; and
a client configured for configuring an export request message for requesting to export at least a part of the converged address book personal information to a non-converged address book system and transmitting the export request message to the server apparatus through the transceiver,
wherein the export request message includes an address of the non-converged address book system, access authentication information of the non-converged address book system, and identification information on the converged address book personal information to be exported.

27. The user terminal as claimed in claim 26, wherein, the client sets a synchronization request for requesting to export changed converged address book personal information to the non-converged address book system in a user preference stored in the server apparatus for the user terminal when the converged address book personal information corresponding to the user terminal is changed.

28. The user terminal as claimed in claim 27, wherein the client receives information on whether the converged address book personal information to be exported or the changed converged address book personal information is exported to the non-converged address book system through the transceiver.

29. The method as claimed in claim 4, further comprising transmitting the status information on whether the synchronization personal information is exported to the non-converged address book system to the user terminal.

30. The server apparatus as claimed in claim 15, wherein the status information on whether the synchronization personal information is exported to the non-converged address book system is transmitted to the user terminal.
